(19) United States
(12) Patent Application Publication
(10) Pub. No.: US 2024/0070128 A1
(43) Pub. Date: Feb. 29, 2024

(54) METHODS AND APPARATUS FOR GENERATING CLEAN DATASETS FROM IMPURE DATASETS

(71) Applicant: Walmart Apollo, LLC, Bentonville, AR (US)

(72) Inventors: Neil Mohan Reddy Palleti, Cupertino, CA (US); Mridul Jain, Cupertino, CA (US); Saigopal Thota, Fremont, CA (US); Rijul Magu, At, GA (US); Puja Maniktala, San Jose, CA (US)

(21) Appl. No.: 17/823,493

(22) Filed: Aug. 30, 2022

(51) Int. Cl. G06F 16/215; G06Q 30/02

(52) U.S. Cl. CPC G06F 16/215; G06Q 30/0201

(57) ABSTRACT

In some examples, a system may, obtain constraint data and customer profile data of a plurality of customers associated with the system. Moreover, for each customer of the plurality of customers, the system may, based on the customer profile data of the customer and the constraint data, generate a score associated with one or more constraints of the plurality of constraints, based on the score of each of the one or more constraints, generate an overall score, and associate the overall score with a customer profile of the customer. Further, the system may, implement operations that generate a clean dataset based on the overall score associated with a customer profile of each of the plurality of customers.

### TECHNICAL FIELD

The disclosure relates to methods and apparatuses for generating clean datasets from impure datasets.

### BACKGROUND

In various examples, e-commerce entities may utilize computing systems that determine insights from high-dimensional data. Additionally, such insights may enable the computing systems of the e-commerce entities to determine historical purchase trends, purchase patterns, purchase motivations, channel specific spending behavior, future public interest, and etc. Moreover, the computing systems of the e-commerce entity may rely on such insights and determinations to forecast future purchase patterns and shape business strategies (e.g., construct advertisement campaigns and personalize user experiences over one or more channels of the e-commerce entity). However, the high-dimensional data the computing systems of the e-commerce entities utilize, may be noisy, sparse and fragmented. Data with high levels of sparsity, noise and fragmentation may negatively affect the accuracy of such insights, determinations and forecasts.

### SUMMARY

The embodiments described herein are directed to a computing system that generates high-quality and clean subsets of data from the high-dimensional noisy, sparse and/or fragmented data. In some instances, the computing system may generate such high-quality and clean subsets of data from the high-dimensional noisy, sparse and/or fragmented data based on lower-dimensional and more easily verifiable/verified data. In other instances, the high-quality and clean subsets of data generated from the high-dimensional noisy data may then be utilized by other computing systems to, for example, understand historical trend, predict future patterns, and determine and shape business strategies.

In accordance with some embodiments, exemplary computing systems may be implemented in any suitable hardware or hardware and software, such as in any suitable computing device. In some embodiments, a computing system may include a memory resource storing instructions and one or more processors coupled to the memory resource. In some examples, the one or more processors may be configured to execute the instructions to obtain constraint data. In some examples, the constraint data may include data that identifies and characterizes a plurality of constraints and data that, for each of the plurality of constraints, identifies and characterizes a global distribution associated with the corresponding constraint. Additionally, the one or more processors may be configured to obtain customer profile data of a plurality of customers associated with the computing system. Moreover, the one or more processors may be configured to, for each customer of the plurality of customers, based on the customer profile data of the customer and the constraint data, implement operations that generate a score associated with one or more constraints of the plurality of constraints, based on the score of each of the one or more constraints, implement operations that generate an overall score, and associate the overall score with a customer profile of the customer. In some examples, the overall score indicating a closeness between the customer profile data of the customer to at least the global distribution of each of the one or more constraints. Further, the one or more processors may be configured to implement operations that generate a clean dataset based on the overall score associated with a customer profile of each of the plurality of customers.

In other embodiments, a computer-implemented method is provided that includes a obtaining constraint data. In some examples, the constraint data may include data that identifies and characterizes a plurality of constraints and data that, for each of the plurality of constraints, identifies and characterizes a global distribution associated with the corresponding constraint. Additionally, the computer-implemented method may further include obtaining customer profile data of a plurality of customers associated with the computing system. Moreover, the computer-implemented method may further include, for each customer of the plurality of customers, based on the customer profile data of the customer and the constraint data, implementing operations that generate a score associated with one or more constraints of the plurality of constraints, based on the score of each of the one or more constraints, implementing operations that generate an overall score, and associating the overall score with a customer profile of the customer. In some examples, the overall score indicating a closeness between the customer profile data of the customer to at least the global distribution of each of the one or more constraints. Further, the computer-implemented method may further include implementing operations that generate a clean dataset based on the overall score associated with a customer profile of each of the plurality of customers.

In various embodiments, a non-transitory computer readable medium has instructions stored thereon, where the instructions, when executed by the at least one or more processors, cause a computing system to, obtain constraint data. In some examples, the constraint data may include data that identifies and characterizes a plurality of constraints and data that, for each of the plurality of constraints, identifies and characterizes a global distribution associated with the corresponding constraint. Additionally, the computing system may obtain customer profile data of a plurality of customers associated with the computing system. Moreover, the computing system may be configured to, for each customer of the plurality of customers, based on the customer profile data of the customer and the constraint data, implement operations that generate a score associated with one or more constraints of the plurality of constraints, based on the score of each of the one or more constraints, implement operations that generate an overall score, and associate the overall score with a customer profile of the customer. In some examples, the overall score indicating a closeness between the customer profile data of the customer to at least the global distribution of each of the one or more constraints. Further, computing system may implement operations that generate a clean dataset based on the overall score associated with a customer profile of each of the plurality of customers.

### BRIEF DESCRIPTION OF THE DRAWINGS

The features and advantages of the present disclosures will be more fully disclosed in, or rendered obvious by the following detailed descriptions of example embodiments. The detailed descriptions of the example embodiments are to be considered together with the accompanying drawings wherein like numbers refer to like parts and further wherein:

FIG. 1 is a block diagram of an example computing environment 100 that includes a clean data computing device 102;

FIG. 2 illustrates a block diagram of example clean data computing device 102 of FIG. 1 in accordance with some embodiments;

FIG. 3 is a block diagram illustrating examples of various portions of the clean data computing device 102 of FIG. 1 in accordance with some embodiments;

FIG. 4 illustrates an example method that can be carried out by the clean data computing device 102 of FIG. 1; and

FIG. 5 illustrates an example fragmented data.

### DETAILED DESCRIPTION

The description of the preferred embodiments is intended to be read in connection with the accompanying drawings, which are to be considered part of the entire written description of these disclosures. While the present disclosure is susceptible to various modifications and alternative forms, specific embodiments are shown by way of example in the drawings and will be described in detail herein. The objectives and advantages of the claimed subject matter will become more apparent from the following detailed description of these exemplary embodiments in connection with the accompanying drawings.

It should be understood, however, that the present disclosure is not intended to be limited to the particular forms disclosed. Rather, the present disclosure covers all modifications, equivalents, and alternatives that fall within the spirit and scope of these exemplary embodiments. The terms “couple,” “coupled,” “operatively coupled,” “operatively connected,” and the like should be broadly understood to refer to connecting devices or components together either mechanically, electrically, wired, wirelessly, or otherwise, such that the connection allows the pertinent devices or components to operate (e.g., communicate) with each other as intended by virtue of that relationship.

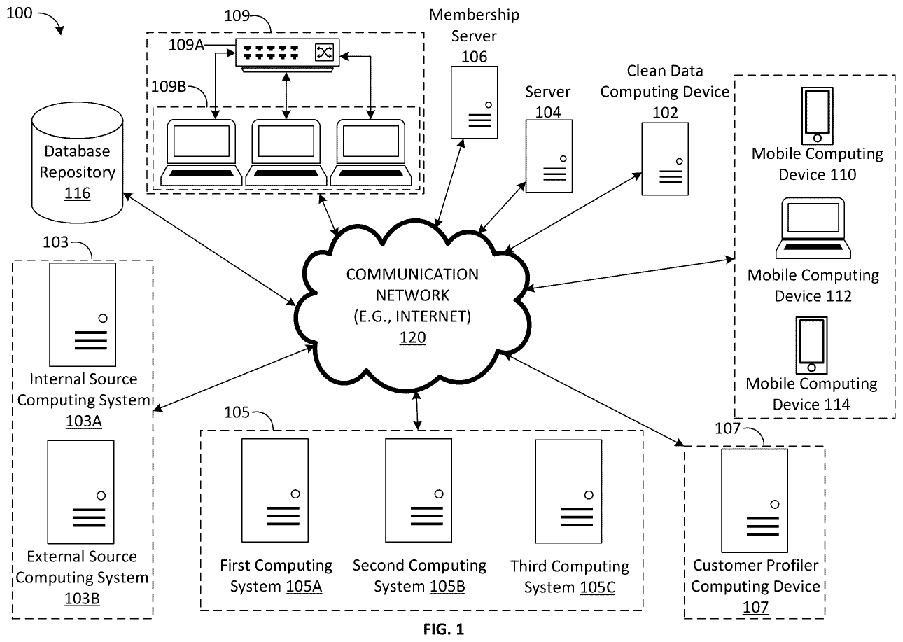

FIG. 1 illustrates a block diagram of an example computing environment 100 that includes clean data computing device 102 (e.g., a server, such as an application server), source computing system(s) 103 (including internal source computing system 103A and external source computing system 103B), a server 104, multiple computing systems 105, such as first computing system 105A, second computing system 105B and third computing system 105C, membership server 106, customer profiler computing system 107 (including customer profiler computing device 107A), multiple mobile computing devices 110, 112, and 114, and data repository 116 operatively coupled over communication network 120. Clean data computing device 102, source computing systems 103 (including internal source computing system 103A and external source computing system 103B), server 104, multiple computing systems 105, such as first computing system 105A, second computing system 105B and third computing system 105C, membership server 106, customer profiler computing system 107 (including customer profiler computing device 107A) and multiple mobile computing devices 110, 112, and 114 may each be any suitable computing device that includes any hardware or hardware and software combination for processing and handling information. For example, each can include one or more servers, one or more processors, one or more field-programmable gate arrays (FPGAs), one or more application-specific integrated circuits (ASICs), one or more state machines, digital circuitry, or any other suitable circuitry. In addition, each can transmit data to, and receive data from, communication network 120.

In some examples, clean data computing device 102 can be a computer, a workstation, a laptop, a server such as a cloud-based server, or any other suitable device. In other examples, each of multiple mobile computing devices 110, 112, and 114 can be a cellular phone, a smart phone, a tablet, a personal assistant device, a voice assistant device, a digital assistant, a laptop, a computer, or any other suitable device. In various examples, each of multiple computing systems 105, such as first computing system 105A, second computing system 105B, third computing system 105C, may represent a computing system that includes one or more servers and tangible, non-transitory memories storing executable code and application modules.

In some examples, clean data computing device 102 is operated by an operator or administrator of an e-commerce entity, and multiple mobile computing devices 110, 112, and 114 are operated by customers of the e-commerce entity. In other examples, each of multiple computing systems 105, such as first computing system 105A, second computing system 105B, third computing system 105C, may be associated with a particular channel of the e-commerce entity. A particular computing system 105 may be configured to implement a set of operations associated with the particular channel of the e-commerce entity, such as determining/predicting future purchase patterns of one or more customers of the e-commerce entity, determining/generating digital content campaigns for each of the customers of the e-commerce entity, and personalizing user experiences associated with the particular channel. Although FIG. 1 illustrates three mobile computing devices 110, 112, and 114, and three computing systems 105A, 105B and 105C, computing environment 100 can include any number of mobile computing devices 110, 112, 114 and computing systems 105A, 105B and 105C. Similarly, computing environment 100 can include any number of clean data computing device 102, server 104, source computing system 103, and data repository 116.

In some examples, server 104 may host one or more webpages, such as a website for the e-commerce entity (e.g., a retailer's website). The one or more webpages may enable a customer to purchase one or more items provided by the e-commerce entity, via a mobile computing device, such as mobile computing device 110, 112, 114), the customer is operating. Additionally, or alternatively, server 104 may support and maintain an application program associated with the e-commerce entity. The application program may be executed on a mobile computing device (mobile computing device 110, 112, 114) of a customer/user of the e-commerce entity. Further, the application program may allow for the purchase of items provided by the e-commerce entity.

Additionally, server 104 may transmit online-transaction data related to orders purchased, either from the application program or the one or more webpages, to customer profiler computing system 107. In some examples, in response to and based at least on the received online-transaction data, customer profiler computing system 107 may generate a customer profile for each customer interacting with the application program and/the one or more web pages. For example, customer profiler computing system 107 may determine and/or identify, for each customer interacting with the application program and/the one or more web pages, a customer identifier or data that identifies the customer (e.g., an email address, a phone number, a membership number, etc.). Additionally, customer profiler computing system 107 may access data repository 116 to determine whether a customer profile or customer profile data exists by comparing a customer identifier of customer profile or customer profile data stored in data repository 116 with the determined or identified customer identifier of the received online-transaction data.

In examples where customer profiler computing system 107 determines the data repository 116 does not include customer profiles or customer profile data with a customer identifier determined or identified from the received online-transaction data, customer profiler computing system 107 may generate a customer profile or customer profile data. The customer profile or customer profile data may be associated with the determined or identified customer identifier. The customer profile or customer profile data may include additional data from the received online-transaction data. For instance, based on the determined or identified customer identifier, the customer profiler computing system 107 may identify, from the received online-transaction data, the additional data associated with the determined or identified customer identifier. Additionally, the customer profiler computing system 107 may include, link or associate the identified additional data to the generated customer profile with the same customer identifier. In some examples, customer profiler computing system 107 may also store the generated customer profile or customer profile data, within a corresponding data repository 116, such as customer profile data.

In examples where customer profiler computing system 107 determines data repository 116 includes a customer profile or customer profile data with a customer identifier determined or identified from the received online-transaction data, customer profiler computing system 107 may update the corresponding customer profile or customer profile data with additional data of the received online-transaction data. For example, customer profiler computing system 107 may identify, from the online-transaction data, the additional data associated with the determined or identified customer identifier. Additionally, the customer profiler computing system 107 may include, link or associate the identified additional data to the existing customer profile or customer profile data with the same customer identifier.

Examples of the additional data of the online-transaction data include data identifying and characterizing one or more online-purchase events, data identifying, for each online-purchase event, one or more items purchased by the customer (e.g., a universal product code (UPC) associated with corresponding item), data identifying a time and/or date of each online-purchase event, data identifying payment information associated with each online-purchase event (e.g., information related to the payment method the corresponding customer is using to complete a transaction associated with the purchase event, such as a credit card number), and data identifying a mobile computing device (e.g., mobile computing device 110, 112, 114) involved with each of the one or more purchase events.

In some examples, server 104 may transmit user session data of each customer interacting with the application program and/the one or more web pages to customer profiler computing system 107. Additionally, in response to and based on receiving the user session data, customer profiler computing system 107 may include, link or associate the user session data with corresponding customer profile or customer profile data. For example, based on the received user session data, customer profiler computing system 107 may determine and/or identify, for each customer interacting with the application program and/the one or more web pages, a customer identifier or data that identifies the customer (e.g., an email address, a phone number, a membership number, etc.). Additionally, customer profiler computing system 107 may access data repository 116 to determine whether a customer profile or customer profile data exists by comparing a customer identifier of customer profile or customer profile data stored in data repository 116 and the determined or identified customer identifier of the user session data.

In examples where customer profiler computing system 107 determines data repository 116 includes a customer profile or one or more portions of customer profile data with a customer identifier determined or identified from the received user session data, customer profiler computing system 107 may update the corresponding customer profile or customer profile data with one or more portions of the received user session data. For example, customer profiler computing system 107 may identify the one or more portions of the user session data that are associated with the determined or identified customer identifier. Additionally, customer profiler computing system 107 may include, link or associate the identified one or more portions of the user session data to the existing customer profile or one or more potions of customer profile data with the same customer identifier.

In examples where customer profiler computing system 107 determines data repository 116 does not include a customer profile or one or more portions of customer profile data with a customer identifier determined or identified from the received user session data, customer profiler computing system 107 may generate a customer profile or customer profile data. The customer profile or customer profile data may be associated with the determined or identified customer identifier. The customer profile or customer profile data may include one or more portions of user session data associated with the corresponding determined or identified customer identifier of the received user session data. For instance, based on determined or identified customer identifier, the customer profiler computing system 107 may identify the one or more portions of user session data associated with the determined or identified customer identifier. Additionally, the customer profiler computing system 107 may include, link or associate the identified one or more portions of user session data to the generated customer profile with the same customer identifier. In some examples, customer profiler computing system 107 may also store the generated customer profile or customer profile data, within a corresponding data repository 116, such as customer profile data.

Examples of the one or more portions of user session data include data identifying and characterizing one or more events associated with one or more sessions of the application program and/or the one or more web pages. Examples of the one or more events associated with the one or more sessions of the application program and/or the one or more webpages includes, add-to-cart events, click events, view events, and impressions associated with a corresponding customer. In some examples, the one or more portions of user session data may include data identifying a mobile computing device (e.g., mobile computing device 110, 112, 114) involved with or associated with each of the sessions of the application program and/or the one or more web pages.

In other examples, membership server 106 may support and maintain membership data. Membership data may include data identifying one or more customers of the e-commerce entity that are currently or have previously participated in the loyalty or membership program associated with the e-commerce entity. Additionally, elements of the membership data may include, but are not limited to, a unique identifier of a particular one of the customers of the e-commerce entity that has currently or previously participated in the loyalty or membership program (e.g., an alphanumeric identifier or login credential, a customer name, etc.), a label or tag identifying whether the particular customer is currently or previously a trial or full member, a timestamp indicating when the user joined the loyalty or membership program, information identifying the type of loyalty or membership program the particular customer signed up for (e.g., trial—15 day, trial 30 day, monthly full membership, and yearly full membership), information identifying the sign up trial type (e.g., annual or monthly), information identifying the trial-membership plan type (e.g., delivery unlimited, in-home deliver, etc.), information identifying the remaining amount of time of a currently active membership of the particular customer, information identifying whether the particular one of the customers cancelled their respective loyalty or membership program (trial or full), a corresponding cancellation tag or label indicating whether the customer explicitly cancelled or let their trial-membership lapse, and corresponding information identifying whether the particular customer had upgraded or converted their trial-membership to a full-membership.

Further, membership server 106 may transmit the membership data to customer profiler computing system 107. Customer profiler computing system 107 may store the membership data within a corresponding data repository 116, such as customer profile data. For example, in response to and based at least on the received membership data, customer profiler computing system 107 may determine and/or identify one or more customer identifiers of one or more customers based on the received membership data. Additionally, customer profiler computing system 107 may access data repository 116 to determine whether a customer profile or customer profile data exists by comparing a customer identifier of customer profile or customer profile data stored in data repository 116 and the determined or identified customer identifier of the received membership data.

In examples where customer profiler computing system 107 determines data repository 116 does not include customer profiles or customer profile data with a customer identifier determined or identified from the received membership data, customer profiler computing system 107 may generate a customer profile or customer profile data. The customer profile or customer profile data may be associated with the determined or identified customer identifier. The customer profile or customer profile data may include one or more portions of the received membership data. For instance, based on determined or identified customer identifier, the customer profiler computing system 107 may identify one or more portions of membership data associated with the determined or identified customer identifier. Additionally, the customer profiler computing system 107 may include, link or associate the identified one or more portions of membership data to the generated customer profile with the same customer identifier. In some examples, customer profiler computing system 107 may also store the generated customer profile or customer profile data, within a corresponding data repository 116, such as customer profile data.

In examples where customer profiler computing system 107 determines data repository 116 includes a customer profile or customer profile data with a customer identifier determined or identified from the received membership data, customer profiler computing system 107 may update the corresponding customer profile or customer profile data with one or more portions of the received membership data. For example, customer profiler computing system 107 may identify the one or more portions of the membership data that are associated with the determined or identified customer identifier. Additionally, customer profiler computing system 107 may include, link or associate the identified one or more portions of the membership data to the existing customer profile or customer profile data with the same customer identifier.

Computing environment 100 may include workstation(s) 109B. Workstation(s) 109B are operably coupled to communication network 120 via router (or switch) 109A. Workstation(s) 109B and/or router 109A may be located at particular store associated with computing environment 100, such as a store 109. Although FIG. 1 illustrates a single store 109, computing environment 100 may include any number of stores, including store 109. Workstation(s) 109A can communicate with customer profiler computing system 107, such as customer profiler computing device 107A, over communication network 120. Workstation(s) 109B may send data to, and receive data from, customer profiler computing system 107, customer profiler computing device 107A. In some examples, workstation(s) 109B may transmit in-store transaction data associated with a particular store 109 of the e-commerce entity, to customer profiler computing system 107, customer profiler computing device 107A. Customer profiler computing system 107 may determine, in response to and based on the received in-store transaction data, for each customer visiting and/or interacting with the particular store 109, a customer identifier or data that identifies the customer (e.g., an email address, a phone number, a membership number, etc.). Additionally, customer profiler computing system 107 may access data repository 116 to determine whether a customer profile or customer profile data exists by comparing a customer identifier of customer profile or customer profile data stored in data repository 116 and the determined or identified customer identifier of the received in-store transaction data.

In examples where customer profiler computing system 107 determines data repository 116 does not include a customer profile or customer profile data with a customer identifier determined or identified from the received in-store transaction data, customer profiler computing system 107 may generate a customer profile or customer profile data. The customer profile or customer profile data may be associated with the determined or identified customer identifier. The customer profile or customer profile data may include additional data from the received in-store transaction data. For instance, based on determined or identified customer identifier, the customer profiler computing system 107 may identify, from the received in-store transaction data, the additional data associated with the determined or identified customer identifier. Additionally, the customer profiler computing system 107 may include, link or associate the identified additional data to the generated customer profile with the same customer identifier. In some examples, customer profiler computing system 107 may also store the generated customer profile or customer profile data, within a corresponding data repository 116, such as customer profile data. In some examples, clean data computing device 102 may also store the generated customer profile or customer profile data, within a corresponding data repository 116, such as customer profile data.

In examples where customer profiler computing system 107 determines data repository 116 includes a customer profile or customer profile data with a customer identifier determined or identified from the received in-store transaction data, customer profiler computing system 107 may update the corresponding customer profile or customer profile data with additional data of the received store transaction data. For example, based on the determined or identified customer identifier, customer profiler computing system 107 may identify, from the received in-store transaction data, the additional data associated with the determined or identified customer identifier. Additionally, the customer profiler computing system 107 may include, link or associate the identified additional data to the existing customer profile or customer profile data with the same customer identifier.

Examples of the additional data of the in-store transaction data include data identifying a store ID of store 109 the customer visited or interacted with, such as store 109, transaction data identifying and characterizing one or more purchase events of the customer at store 109, data identifying, for each purchase events, one or more items purchased by the customer at store 109 (e.g., a universal product code (UPC) associated with corresponding item), data identifying a time and/or date of each purchase event, data identifying a payment instrument (e.g., information related to the payment method the corresponding customer is using to complete a transaction associated with the purchase event, such as a credit card number), data identifying and characterizing a location of store 109 (e.g., e.g., an address, geographical coordinates, etc.).

Referring back to FIG. 1, each of source computing systems 103 (e.g., internal source computing system 103A and external source computing system 103B) may include a tangible, non-transitory memory. Additionally, each of source computing systems 103 may maintain, within corresponding tangible, non-transitory memories, a data repository that includes internal source data associated with customers of the e-commerce entity. In some examples, internal source computing system 103A may be associated with, and/or operated by one or more operators or administrators of the e-commerce entity. Additionally, internal source computing system 103A may, obtain, from one or more data sources, such as workstation(s) 109B, server 104 and/or membership server 106, data (e.g., engagement data, online-transaction data, in-store transaction data, or membership data) that identifies or characterizes customers of the e-commerce entity. Further, internal source computing system 103A may generate internal source data based on the obtained data.

In some instances, internal source computing system 103A may parse the obtained data by one or more predefined characteristics or features associated with the customers of the e-commerce entity. Additionally, internal source computing system 103A may determine, for each predefined characteristic or feature associated with the customers of the e-commerce entity, a global distribution and a metric associated with the global distribution. Moreover, internal source computing system 103A may generate internal source data that includes data identifying and characterizing, for each predefined characteristic or feature associated with the customers of the e-commerce entity, a global distribution and corresponding metric. Examples of the one or more predefined features that the global distributions and corresponding metrics may be associated with include channel features (e.g., channel breakdown ratios), in-store visit features (e.g., average number of trips to particular store(s), week-over-week trends for store visits, etc.), membership features (e.g., ratios of customers with various memberships), payment features (e.g., ratios of payment types), location features (e.g., distribution of customer by location), and online activity features (e.g., online activity ratios, week-over-week trends for online visits, etc.). In some instances, the internal source data may be of lower dimensionality than the customer profile or customer profile data because the internal source data includes ground truth information.

In various examples, the obtained data may include survey data that identifies and characterizes the results of one or more surveys conducted by one or more representatives of an e-commerce entity. An example of a survey may include a survey of the number of customers that visit a particular store 109 per day during a predetermined time interval, such as six months. In such examples, the survey data may be transmitted to internal source computing system 103A from a mobile computing device operated by a representative of the ecommerce entity (not shown in FIG. 1).

In other examples, external source computing system 103B may be associated with or operated by, a third-party vendor. Additionally, external source computing system 103B may maintain a source data repository that includes elements of third-party agency data. In some examples, the data records of third-party agency data may include reporting data associated with the customers of the e-commerce entity, such as consumer reports. In such examples, the reporting data may be of lower dimensionality than the customer profile or customer profile data because the reporting data includes ground truth information. Additionally, the reporting data may include data identifying and characterizing, for each predefined characteristic or feature associated with the customers of the e-commerce entity, a global distribution and corresponding metric. An example of the one or more metrics includes distribution of transactions by product category (e.g., total transaction amount for food purchases).

As illustrated in FIG. 1, each of the source computing systems 103 (e.g., internal source computing system 103A and external source computing system 103B) may perform operations that obtain all or a selected portion of the data records of the internal source data and/or reporting data. Additionally, each of the source computing systems 103 may perform operations to transmit the obtained portions as source data across communication network 120 to clean data computing device 102. Further, clean data computing device 102 may store, within a corresponding data repository 116, such as source data.

Clean data computing device 102 is operable to communicate with data repository 116 over communication network 120. For example, clean data computing device 102 can store data to, and read data from, data repository 116. Data repository 116 can be a remote storage device, such as a cloud-based server, a disk (e.g., a hard disk), a memory device on another application server, a networked computer, or any other suitable remote storage. Although shown remote to clean data computing device 102, in some examples, data repository 116 can be a local storage device, such as a hard drive, a non-volatile memory, or a USB stick.

In some examples, data repository 116 may include a customer database, constraint database, score database and clean dataset database. In some examples, customer database may store customer profile data of customers or a set of customers of an e-commerce entity. As described herein, the customer profile data may identify and characterize a set of customer profiles and each of the set of customer profiles may be associated with a customer of the e-commerce entity. Additionally, the customer profile data may include, for each identified customer profile of the set of customer profiles, a customer identifier or data that identifies the corresponding customer (e.g., an email address, a phone number, a membership number, etc.), corresponding additional data from online-transaction data, corresponding additional data from in-store transaction data, corresponding one or more portions of user session data, and corresponding one or more portions of member data.

In other examples, constraint database may store source data. As described herein, the source data may include data identifying and characterizing, for one or more predefined characteristics or features associated with the customers of the e-commerce entity, a corresponding global distribution and/or a metric associated with the global distribution. Examples of the one or more predefined features that the global distributions and corresponding metrics may be associated with, includes channel features (e.g., channel breakdown ratios), in-store visit features (e.g., average number of trips to particular store(s), week-over-week trends for store visits, etc.), membership features (e.g., ratios of customers with various memberships), payment features (e.g., ratios of payment types), location features (e.g., distribution of customer by location), online activity features (e.g., online activity ratios, week-over-week trends for online visits, etc.), and purchase features (e.g., distribution of transactions by product category, such as total transaction amount for food purchases). Additionally, the source data may be of lower dimensionality than the customer profile or customer profile data because of the inclusion of the ground truth information of the one or more portions of internal source data and/or reporting data.

In some instances, constraint database may store constraint data generated by clean data computing device 102. In such instances, clean data computing device 102 may utilize source data to generate constraint data. For example, clean data computing device 102 may obtain, from source computing systems 103 (e.g., internal source computing system 103A and external source computing system 103B) or constraint database, source data. Additionally, clean data computing device 102 may identify, from the source data, one or more predefined characteristics or features associated with the customers or e-commerce entity, and corresponding data identifying and characterizing the associated global distribution and/or related metric. Moreover, clean data computing device 102 may generate constraint data based on the one or more predefined characteristics or features associated with the customers or e-commerce entity, and corresponding data identifying and characterizing the associated global distribution and related metric. The constraint data may identify one or more constraints. Each of the one or more constraints may correspond to one of the identified global distributions and related metric. In various instances, the constraint data may include data that characterizes, for each of the one or more constraints, the corresponding global distribution and related metric, and associated feature. In some instances, clean data computing device 102 may store the constraint data, within a corresponding data repository 116, such as the constraint data. The constraint data may be of lower dimensionality than the customer profile or customer profile data because the source data that the constraint data is based off of (including one or more portions of internal source data and reporting data) includes ground truth information.

In various examples, score database may store score data generated by clean data computing device 102. In such examples, score data may identify and characterize, for each customer profile of the set of customer profiles, a score associated with each constraint identified from constraint data, the associated constraint, and an associated customer identifier of a corresponding customer profile. The score may indicate how close the one or more portions of the high dimensional data of the customer profile or customer profile data related to the global distribution and/or related metric of a corresponding constraint is to the global distribution and/or related metric of the constraint (e.g., the average number of trips to store 109 within a particular year). In such instances, clean data computing device may generate and store score data that identifies and characterizes the determined scores within a corresponding data repository 116, such as score database.

In some examples, clean data database may store clean datasets of customer profiles generated by clean data computing device 102. In such examples, clean data computing device 102 may generate the clean datasets of customer profiles based on the high-dimensional data included or associated with the set of customer profiles of customers of the e-commerce entity and the constraint data. The clean datasets may include a representative subset of customer profiles of the set of customer profiles and corresponding high-dimensional data. In some instances, clean data computing device 102 may store, within a corresponding data repository 116, the clean datasets.

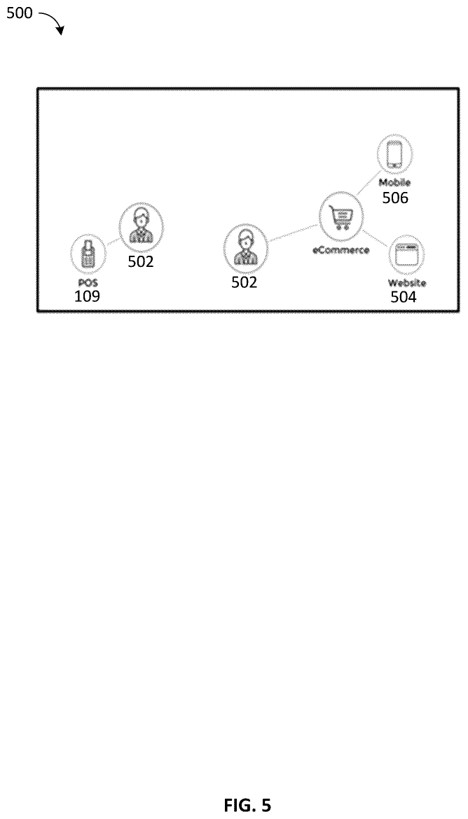

As described herein, the data associated with or included with each customer profile may be high-dimensional but also noisy and sparse due to sub-optimal manual data collection processes or technical glitches in the automated data collection process. Additionally, one or more customers may have fragmented customer profiles (e.g., each of the one or more customers having associated multiple customer profiles). For example, as illustrated in FIG. 5, a customer 502 may use a credit card to complete an in-store transaction in store 109 and may provide a first customer identifier, such as an email or phone number, when completing the in-store transaction in store 109. Workstation(s) 109B may transmit in-store transaction data of the customer 502 to customer profiler computing system 107. Additionally, customer profiler computing system 107 may identify, from the in-store transaction data, the first customer identifier of the customer 502 and additional data of the in-store transaction data associated with the first customer identifier. Moreover, customer profiler computing system 107 may associate or include the identified additional data to an existing customer profile associated with the identified customer identifier or generate a new customer profile associated with the identified customer identifier that includes or is associated with the identified additional data. Moreover, the customer 502 may also use a utilize a website 504 or application associated with an e-commerce entity executing a mobile computing device operated by the customer (e.g., mobile computing device 110, 112, 114) to make an online-transaction. Server 104 may transmit online-transaction data of the customer 502 to customer profiler computing system 107 and customer profiler computing system 107 may identify, from the online-transaction data, a second customer identifier that the customer 502 provided when making the online transaction and additional data associated with the customer 502 based on the second customer identifier. The second customer identifier may be different from the customer identifier of the in-store transaction data (e.g., the second customer identifier may be an email associated with login information of a website, while the customer identifier of the in-store transaction data may be a different email). The customer profiler computing system 107 may associate or include the identified additional data to an existing customer profile with the of the identified second customer identifier or generate a new customer profile associated with the identified second customer identifier that includes or is associated with the identified additional data. While both customer profiles are associated with the same customer 502, customer profiler computing system 107 may treat them as different because of the different customer identifiers that are derived from the online-transaction data and the in-store transaction data. As such, the data associated with the customer 502 may be fragmented.

As described herein, each of multiple computing system 105 (e.g., first computing system 105A, second computing system 105B, third computing system 105C) may utilize the high-dimensional data associated with or included with customer profiles of the customers of the e-commerce entity to extract insights associated with one or more of the customers (e.g., purchase patterns of one or more of the customers). Additionally, as described herein, each of multiple computing system 105 may implement a set of operations associated with the particular channel of the e-commerce entity, such as determining/predicting future purchase patterns of one or more customers of the e-commerce entity, determining/generating digital content campaigns for each of the customers of the e-commerce entity, and personalizing user experiences associated with the particular channel, based on such insights. In some instances, each of the multiple computing systems 105 may utilize machine learning or artificial intelligence processes when implementing said set of operations or determining such insights. However, if the high dimensional data associated with or included with customer profiles has a high level of sparsity, fragmentation and/or noise, such insights may be inaccurate, and the performance of the set of operations by the multiple computing systems 105 may be negatively affected (e.g., the misallocation of computing resources for the computing systems 105, such as computing system 105A, computing system 105B, computing system 105C).

Clean data computing device 102 may be configured to generate high-quality and clean subsets of data or the clean datasets from the high dimensional data of customer profiles that may have high levels of noise, sparsity and/or fragmentation. In some examples, clean data computing device 102 may utilize the high dimensional data of the set of customer profiles of the e-commerce entity and constraint data to generate the clean dataset. In such examples, clean data computing device 102 may transmit the clean dataset to the computing systems 105. The computing system 105 may utilize the clean dataset to extract insights and may implement the set of operations associated with the particular channel of the e-commerce entity, such as determining/predicting future purchase patterns of one or more customers of the e-commerce entity, determining/generating digital content campaigns for each of the customers of the e-commerce entity, and personalizing user experiences associated with the particular channel, based on such insights.

In various examples, the clean dataset may include a representative subset of customer profiles of the set of customer profiles and corresponding the high dimensional data. For example, clean data computing device 102 may generate, based at least on high dimensional data of the set of customer profiles and one or more constraints identified in constraint data, the clean dataset. The clean dataset may be generated in accordance with the constraint data such that the cumulative high dimensional data of the representative subset of customer profiles closely matches one or more global distributions and/or corresponding metric(s) of the set of customers of the ecommerce entity that are associated with the one or more constraints. As described herein, the high-dimensional data of the representative subset of customer profiles included in the clean dataset may have lower levels of sparsity, fragmentation and/or noise than the high dimensional data of the set of customer profiles.

In some examples, clean data computing device 102 may implement a set of operations that generate the clean dataset of customer profiles. In such examples, the set of operations that clean data computing device 102 may implement include obtaining, from constraint database, constraint data. As described herein, the constraint data may identify one or more constraints and include data that identifies and characterizes, for each of the one or more constraints, the corresponding global distribution and/or related metric, and associated feature. Additionally, the global distribution and/or metric may be ground truth information. Moreover, the set of operations that clean data computing device 102 may implement include determining, for each customer profile, a score for each constraint based on the constraint data, such as the global distributions and/or metric of the constraint, and the high dimensional data of the corresponding customer profile.

For example, clean data computing device 102 may generate the scores by obtaining the high-dimensional data associated with or included with a set of customer profiles of the customer profile data. Additionally, the clean data computing device 102 may, for each constraint, identify a feature associated with the constraint based on the constraint data. Moreover, clean data computing device 102 may determine and identify, from the high dimensional data of each of the set of customer profiles and for each of the set of customer profiles, one or more portions of the corresponding high-dimensional data associated with the feature. Further, clean data computing device 102 may, for each constraint and for each of the one or more customer profiles, determine a corresponding score by comparing the corresponding global distribution of the constraint and/or related metric with the determined and identified one or more portions of high-dimensional data associated with the identified feature. In some instances, a score of a constraint may indicate how close the high dimensional data associated with the corresponding customer profile and the constraint (or identified feature of the constraint) is to the global distribution of the set of customers of the e-commerce entity and/or related metric associated with the constraint (or identified feature of the constraint).

In some examples, a global distribution of a feature may be associated with a particular type of distribution, such as a discrete probability mass function or continuous probability density function. In such examples, clean data computing device 102 may determine a score of a particular constraint for a particular customer, based in part on the type of distribution associated with the global distribution of the particular constraint. In some instances, a constraint identified in constraint data may be associated with a global distribution that is an exponential distribution with a large number of discrete buckets. As an example, the constraint may be associated with an in-store visit feature and the global distribution associated with the in-store visit feature may be associated with an average number of trips to store 109 in the past year. Additionally, the global distribution may be associated with an exponential distribution with a large number of discrete buckets (one for every possible number of visits). In such an example, clean data computing device 102 may identify the in-store visit feature, the average number of trips to store 109, associated with a first constraint identified in the constraint data. Additionally, clean data computing device 102 may identify, for each of the set of customer profiles, one or more portions of high-dimensional data related to the number of in-store visits of the corresponding customer to store 109. Moreover, clean data computing device 102 may, for each of the set of customers, compare the corresponding one or more portions of high-dimensional data related to the number of in-store visits of the corresponding customer to store 109 with the global distribution and/or related metric of the in-store visit feature (e.g., by applying the global distribution of the in-store visit feature to the one or more portions of high-dimensional data related to the number of in-store visits of the corresponding customer to store 109). Based on the comparison, clean data computing device 102 may generate, for each customer, a score. The score may indicate how close the one or more portions of the high dimensional data related to the number of in-store visits of the corresponding customer to store 109 is to the global distribution of the set of customers and/or related metric of the in-store visit feature, such as the average number of trips to store 109.

In some instances, clean data computing device 102 may determine additional information associated with the one or more portions of high-dimensional data and compare the additional information to the global distribution and/or related metric of the feature. Following the example above, for example, clean data computing device 102 may determine, for each customer profile, a number of visits the customer has made to store 109 in the past year (e.g., 5 times in the past year) based on the one or more portions of high-dimensional data related to the number of in-store visits of the corresponding customer to store 109. Additionally, clean data computing device 102 may, for each customer, compare the corresponding determined number of visits the customer has made to store 109 in the past year to the global distribution of the in-store visit feature and/or related metric, such as, for the set of customers visiting store 109 in the past year, an exponential distribution with an average of 25 trips.

In other instances, a constraint identified in constraint data may be associated with a global distribution that is a distribution with a small number of discrete buckets. As an example, the constraint may be associated with a channel feature and the global distribution associated with the channel feature may be associated with overall channel breakdown of customers or channel break down ratio. Additionally, the overall channel breakdown of customers or channel breakdown ratio may include a small number of discrete buckets. For instance, the overall channel breakdown of customers or channel breakdown ratio may include a bucket associated with the percentage of customers that only make online-transactions, a bucket associated with percentage of customers that only make in-store transactions, and a bucket associated with percentage of customer that make both in-store transactions and online-transactions. Additionally, each of the small number of discrete buckets may be associated with or assigned a true ratio based on the on-line transaction data and/or in-store transaction data of the set of customers of the e-commerce entity (e.g., the percentage or ratio of online-transactions to in-store transactions to both online and store transactions may be 20%:40%:40%). In such an instance, clean data computing device 102 may identify the channel feature, the overall channel breakdown of customers or channel breakdown ratio associated with the constraint identified in the constraint data. Additionally, clean data computing device 102 may identify, for each of the set of customer profiles, one or more portions of high-dimensional data related to online and/or in-store transactions. Moreover, based on the one or more portions of high-dimensional data of each of the set of customer profiles, clean data computing device 102 may, determine, for each customer profile, whether the corresponding customer only makes purchases online, only makes purchases in-store or both. Further, clean data computing device 102 may, determine, for each customer profile, which discrete bucket the customer profile falls into based on whether the corresponding customer only makes transactions online, only makes transactions in-store or makes both online and in-store transactions. Based on which discrete bucket the customer profile falls into, clean data computing device 102 may determine a score for the corresponding customer profile in accordance with the corresponding true ratio or percentage associated with the discrete bucket the corresponding customer profile falls into. For instance, clean data computing device 102 may determine, based on one or more portions of high-dimensional data of a particular customer profile associated with the channel feature (e.g., the high-dimensional data related to online and/or in-store transactions), the corresponding customer only makes on-line purchases. As such, clean data computing device 102 may determine that the customer profile may receive a score of 0.2.

In various instances, a constraint identified in the constraint data may be associated with a global distribution that is a time series distribution with a large number of overlapping buckets. As an example, the constraint may be associated with a purchase feature and the global distribution may be associated with a distribution of transactions of a set of customer of an e-commerce entity by product category over a particular time interval. For instance, the distribution of transactions of a set of customer of an e-commerce entity by product category over a particular time interval may be the total purchase amount of the set of customers related to food items per week, for the last three years. In such an example, clean data computing device 102 may identify the purchase feature and the global distribution. Additionally, clean data computing device 102 may identify, for each of the set of customer profiles, one or more portions of high dimensional data (e.g., online-transactional data and/or in-store transactional data) related to the purchase amount of food items for the last three years. Based on the one or more portions of high-dimensional data, clean data computing device 102 may determine, for each of the set of customer profiles, a week-to-week, during the three-year time period, total purchase amount related to food items. In such an instance, clean data computing device 102 may compare, for each of the set of customer profiles, the determined week-to-week total purchase amount related to food items to the global distribution of the total purchase amount per week for the three-year time interval. Based on the comparison, clean data computing device 102 may determine, for each of the set of customer profiles, a score. In some instances, clean data computing device 102 may determine the score by utilizing similarity/distance measures (e.g., cosine similarity, mean squared error, etc.).

In some examples, the set of operations that clean data computing device 102 may implement to generate the clean datasets of customer profiles may include de-fragmentation operations. In such examples, the de-fragmentation operations remove or lessen the effects of fragmentation-related impurities (e.g., lessen the chance the fragmented customer profiles of one or more customers are included in the clean datasets). Additionally, the de-fragmentation operations that clean data computing device 102 may implement may include normalizing the scores of each constraint associated with each of set customer profiles identified in the customer profile data. In some instances, normalizing the scores may include normalizing the size of each discrete bucket of the global distributions of each constraint. For instance, clean data computing device 102 may determine the actual distribution of the set of customers that have the associated score, and then normalize the score of a particular customer utilizing the determined actual distribution (e.g., dividing the score of the customer with the actual distribution).

As an example, following the example regarding the constraint associated with channel feature, given the small number of discrete buckets, each customer profile of the set of customers of the e-commerce entity may have a score of 0.2 if the high-dimensional data of the corresponding customer profile indicates the corresponding customer only shops online, 0.4 if the high-dimensional data of the corresponding customer profile indicates the corresponding customer only in-store (e.g., store 109), or 0.4 if the high-dimensional data of the corresponding customer profile indicates the corresponding customer shops online and in-store. Additionally, clean data computing device 102 may, based on the global distribution of the set of customers associated with the channel feature, determine the actual distribution of customers that only shop online, only in-store, and online and in-store are 8%, 54% and 38%, respectively. Based on the determined actual distribution of customers and the scores of the channel feature constraint of the set of customer profiles of customers of the e-commerce entity, clean data computing device 102 may determine, for each of the set of customer profiles, the normalized score associated with the channel feature constraint. For instance, for each of the set of customer profiles, clean data computing device 102 may divide the scores associated with the channel feature constraint by the corresponding actual distribution (e.g., for customer profiles with the high-dimensional data indicating the corresponding customer only shops online, clean data computing device 102 may divide the score of 0.2 by the actual distribution of customers that only shop online—0.08; for customer profiles with the high-dimensional data indicating the corresponding customer only shops in-store, clean data computing device 102 may divide the score of 0.4 by the actual distribution of customers that only shop online—0.54; and for customer profiles with the high-dimensional data indicating the corresponding customer shops online and in-store, clean data computing device 102 may divide the score of 0.4 by the actual distribution of customers that only shop online—0.38).

As an another example, following the example regarding the constraint associated with an in-store visit feature, given the large number of discrete buckets for the exponential type distribution, a particular customer profile of the set of customers of the e-commerce entity may have a score of 0.15 for the determined six visits to store 109 in the past year. Additionally, clean data computing device 102 may, based on the global distribution of the set of customers associated with the in-store visit feature, determine the actual distribution of customers that visited a store of e-commerce entity six times in the past year is 20%. Based on the determined actual distribution of customers and the score of the in-store visit feature constraint of the particular customer profile, clean data computing device 102 may determine, for the particular customer profile, the normalized score associated with the in-store visit feature constraint. For instance, for each of the particular customer profile, clean data computing device 102 may divide the score associated with the in-store visit feature constraint by the corresponding actual distribution (e.g., clean data computing device 102 may divide the score of 0.15 by 0.2).

In other examples, the set of operations that clean data computing device 102 may implement to generate the clean datasets of customer profiles may include aggregating, for each of the one or more customer profiles, the normalized scores of each constraint. In some instances, for each customer profile of the set of customer profiles, clean data computing device 102 may aggregate the score of one or more constraints that were determined for the corresponding customer profile. For instance, clean data computing device 102 may obtain, from score database, score data associated with a particular customer profile. The score data may include one or more scores and each score may be associated with a particular constraint. Clean data computing device 102 may aggregate the one or more scores to generate an aggregate score (e.g., by multiplying the individual scores together).

In various examples, the set of operations that clean data computing device 102 may implement to generate the clean dataset of customer profiles may include sampling operations. In some examples, the sampling operations that the clean data computing device 102 may implement include normalizing the aggregate scores of all the customer profiles of the set of customer profiles. In some instances, clean data computing device 102 may normalize the aggregate scores of all the customer profiles of the set of customer profiles such that the aggregate scores of all the customer profiles sum to 1. The normalized aggregate scores may indicate the true probability that a customer profile is to be selected for the clean dataset.

Moreover, the sampling operations that the clean data computing device 102 may implement include selecting a subset of customer profiles from the set of customer profiles for the clean dataset. The selected subset of customer profiles and corresponding high-dimensional data may be included in the clean dataset of customer profiles, based on the normalized aggregate score of each of the set of customer profiles. In some instances, clean data computing device 102 may randomly select the subset of customer profiles from the set of customer profiles. In other instances, clean data computing device 102 may weight each of the aggregate scores of each of the set of customer profiles and then randomly select the subset of customer profiles from the set of customer profiles, without replacement and based on the weighted and normalized aggregate score of each of the set of customer profiles. Further, clean data computing device 102 may generate a clean dataset based on the selected subset of customer profiles. As described herein, the clean dataset of customer profiles may include data that identifies and characterizes each of the selected subset of customer profiles, along with corresponding high-dimensional data. Given that the cumulative high-dimensional data of the customer profiles of the selected subset of customer profiles is determined to closely reflect the global distributions of each constraint the weighted random sampling is based off of, and that the scores were normalized to remove the effects or lessen the fragmentation effects that may exist in the high-dimensional data of the set of customer profiles, the clean dataset may be less noisy, sparse and/or fragmented than the high-dimensional data of the set of customer profiles.

In various examples, given the lower-dimensionality (e.g., the inclusion of ground truth information of one or more aspects or portions of the customer profile data 313) of the constraint data, clean data computing device 102 may implement a set of operations that evaluate whether the clean dataset satisfies the global distributions of one or more constraints. In some instances, clean data computing device 102 may only utilize a portion of the constraints identified in constraint data in generating the clean datasets. In such instances, clean data computing device 102 may utilize the remaining constraints as testing constraints. For instance, when generating the clean dataset, clean data computing device 102 may not have utilized a constraint associated with channel breakdown ratios. As such, clean data computing device 102 may identify the global distribution and/or metric associated with the constraint associated with channel breakdown ratios. Additionally, based on the high-dimensional data of each of the customer profiles included in the clean dataset, clean data computing device 102 may obtain portions of the high-dimensional data that is associated with the constraint and determine and generate aggregate statistics associated with the constraint, (e.g., the ratio of customers identified in the clean dataset of customers, that only shop online, only shop in-store, and shop online and in-store). Further, clean data computing device 102 may determine an accuracy of the clean dataset of customer profiles by comparing the determined and generated aggregate statistics associated with the constraint to the global distribution and/or metric associated with the constraint. In some examples, clean data computing device 102 may reselect the subset of customer profiles if clean data computing device 102 determines the accuracy of the clean dataset is not within an acceptable margin of error. Additionally, clean data computing device 102 may generate another clean dataset based on the reselected subset of customer profiles

In some examples, the number of customer profiles to be selected for a subset of customer profiles, may depend with the number of constraints being utilized in generating the clean dataset, and the acceptable range of error. For example, the larger the number of constraints are used by clean data computing device 102 or the smaller the acceptable margin of error, the smaller the number of customer profiles are to be selected for the subset of customer profiles. Alternatively, in another example, the smaller the number of constraints are used by clean data computing device 102 or the larger the acceptable margin of error, the larger the number of customer profiles are to be selected for the subset of customer profiles.

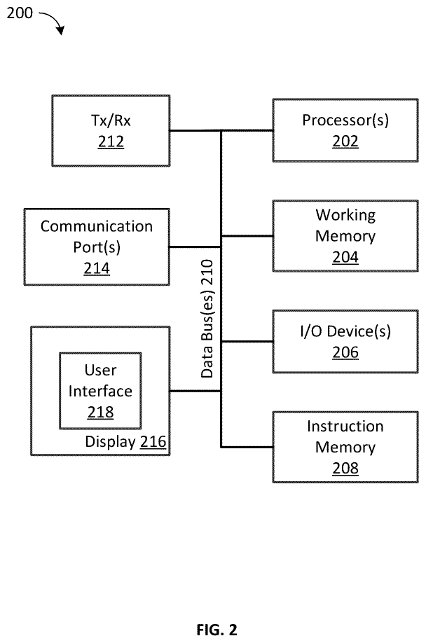

FIG. 2 illustrates a block diagram of example clean data computing device 102 of FIG. 1. Clean data computing device 102 can include one or more processors 202, working memory 204, one or more input/output devices 206, instruction memory 208, a transceiver 212, one or more communication ports 214, and a display 216, all operatively coupled to one or more data buses 210. Data buses 210 allow for communication among the various devices. Data buses 210 can include wired, or wireless, communication channels.

Processors 202 can include one or more distinct processors, each having one or more cores. Each of the distinct processors can have the same or different structure. Processors 202 can include one or more central processing units (CPUs), one or more graphics processing units (GPUs), application specific integrated circuits (ASICs), digital signal processors (DSPs), and the like.

Instruction memory 208 can store instructions that can be accessed (e.g., read) and executed by processors 202. For example, instruction memory 208 can be a non-transitory, computer-readable storage medium such as a read-only memory (ROM), an electrically erasable programmable read-only memory (EEPROM), flash memory, a removable disk, CD-ROM, any non-volatile memory, or any other suitable memory. Processors 202 can be configured to perform a certain function or operation by executing code, stored on instruction memory 208, embodying the function or operation. For example, processors 202 can be configured to execute code stored in instruction memory 208 to perform one or more of any function, method, or operation disclosed herein.

Additionally, processors 202 can store data to, and read data from, working memory 204. For example, processors 202 can store a working set of instructions to working memory 204, such as instructions loaded from instruction memory 208. Processors 202 can also use working memory 204 to store dynamic data created during the operation of clean data computing device 102. Working memory 204 can be a random access memory (RAM) such as a static random access memory (SRAM) or dynamic random access memory (DRAM), or any other suitable memory.

Input/output devices 206 can include any suitable device that allows for data input or output. For example, input/output devices 206 can include one or more of a keyboard, a touchpad, a mouse, a stylus, a touchscreen, a physical button, a speaker, a microphone, or any other suitable input or output device.

Communication port(s) 214 can include, for example, a serial port such as a universal asynchronous receiver/transmitter (UART) connection, a Universal Serial Bus (USB) connection, or any other suitable communication port or connection. In some examples, communication port(s) 214 allows for the programming of executable instructions in instruction memory 208. In some examples, communication port(s) 214 allow for the transfer (e.g., uploading or downloading) of data, such as interaction data, product data, and/or keyword search data.

Display 216 can display user interface 218. User interface 218 can enable user interaction with clean data computing device 102. For example, user interface 218 can be a user interface for an application of a retailer that allows a customer to view and interact with a retailer's website. In some examples, a user can interact with user interface 218 by engaging input/output devices 206. In some examples, display 216 can be a touchscreen, where user interface 218 is displayed on the touchscreen.

Transceiver 212 allows for communication with a network, such as the communication network 108 of FIG. 1. For example, if communication network 108 of FIG. 1 is a cellular network, transceiver 212 is configured to allow communications with the cellular network. In some examples, transceiver 212 is selected based on the type of communication network 108 clean data computing device 102 will be operating in. Processor(s) 202 is operable to receive data from, or send data to, a network, such as communication network 108 of FIG. 1, via transceiver 212.

### Customer Profile Evaluation

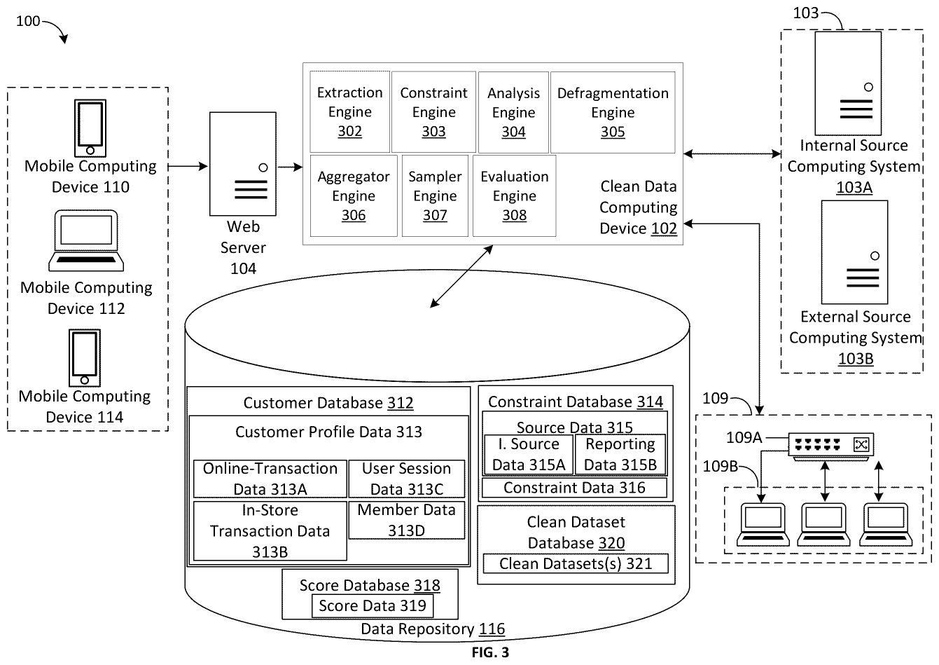

FIG. 3 is a block diagram illustrating examples of various portions of the clean data computing device 102. As illustrated in FIG. 3, clean data computing device 102 can include extraction engine 302, constraint engine 303, analysis engine 304, defragmentation engine 305, aggregator engine 306, sampler engine 307, and evaluation engine 308. In some examples, one or more of extraction engine 302, constraint engine 303, analysis engine 304, defragmentation engine 305, aggregator engine 306, sampler engine 307, and evaluation engine 308 may be implemented in hardware. In other examples, one or more of extraction engine 302, constraint engine 303, analysis engine 304, defragmentation engine 305, aggregator engine 306, sampler engine 307, and evaluation engine 308 may be implemented as an executable program maintained in a tangible, non-transitory memory, such as instruction memory 208 of FIG. 2, that may be executed by one or processors, such as processor 202 of FIG. 2.

As illustrated in FIG. 3, data repository 116, may include customer database 312. Customer database 312 may store one or more data elements of customer profile data 313 of one or more customers of an e-commerce entity. The customer profile data 313 may identify and characterize a customer profile of each of the one or more customers of the e-commerce entity. In some examples, clean data computing device 102 may receive, from one or more data sources, such as server 104, membership server 106 and workstation(s) 109B, one or more data elements of the customer profile data 313. In such examples, the one or more data elements of the customer profile data 313 may include a customer identifier or data that identifies the corresponding customer (e.g., an email address, a phone number, a membership number, etc.) associated with each customer profile. Additionally, the one or more data elements of the customer profile data 313 may include one or more portions of corresponding additional data from online-transaction data 313A, one or more portions of corresponding additional data from in-store transaction data 313B, one or more portions of corresponding user session data 313C, and one or more portions of corresponding membership data 313D.

As described herein, examples of one or more portions of the additional data of the online-transaction data 313A that may be included in the customer profile data 313, include data identifying and characterizing one or more online-purchase events, data identifying, for each online-purchase event, one or more items purchased by the customer (e.g., a universal product code (UPC) associated with corresponding item), data identifying a time and/or date of each online-purchase event, data identifying payment information associated with each online-purchase event (e.g., information related to the payment method the corresponding customer is using to complete a transaction associated with the purchase event, such as a credit card number), and data identifying a mobile computing device (e.g., mobile computing device 110, 112, 114) involved with each of the one or more purchase events.

Additionally, examples of one or more portions of the additional data of the in-store transaction data 313B that may be included in the customer profile data 313, include data identifying a store ID of store 109 the customer visited or interacted with, such as store 109, transaction data identifying and characterizing one or more purchase events of the customer at store 109, data identifying, for each purchase events, one or more items purchased by the customer at store 109 (e.g., a universal product code (UPC) associated with corresponding item), data identifying a time and/or date of each purchase event, data identifying a payment instrument (e.g., information related to the payment method the corresponding customer is using to complete a transaction associated with the purchase event, such as a credit card number), data identifying and characterizing a location of store 109 (e.g., e.g., an address, geographical coordinates, etc.).

Moreover, examples of one or more portions of the additional data of the user session data 313C that may be included in the customer profile data 313, include data identifying and characterizing events associated with sessions of the application program and/or the one or more web pages. Examples of events associated with sessions of the application program and/or the one or more webpages includes, add-to-cart events, click events, view events, and impressions associated with a corresponding customer. In some examples, the one or more portions of user session data may include data identifying a mobile computing device (e.g., mobile computing device 110, 112, 114) involved with or associated with each of the sessions of the application program and/or the one or more web pages.

Further, examples of one or more portions of the additional data of the membership data 313D that may be included in the customer profile data 213, include data identifying and characterizing a unique identifier of a particular one of the customers of the e-commerce entity that has currently or previously participated in the loyalty or membership program (e.g., an alphanumeric identifier or login credential, a customer name, etc.), a label or tag identifying whether the particular customer is currently or previously a trial or full member, a timestamp indicating when the user joined the loyalty or membership program, information identifying the type of loyalty or membership program the particular customer signed up for (e.g., trial—15 day, trial 30 day, monthly full membership, and yearly full membership), information identifying the sign up trial type (e.g., annual or monthly), information identifying the trial-membership plan type (e.g., delivery unlimited, in-home deliver, etc.), information identifying the remaining amount of time of a currently active membership of the particular customer, information identifying whether the particular one of the customers cancelled their respective loyalty or membership program (trial or full), a corresponding cancellation tag or label indicating whether the customer explicitly cancelled or let their trial-membership lapse, and corresponding information identifying whether the particular customer had upgraded or converted their trial-membership to a full-membership.

In other examples, data repository 116 may include constraint database 314. Constraint database 314 may store, source data 315. As described herein, source data 315 may include all or a selected portion of data records of internal source data 315A generated by internal source computing system 103A and/or reporting data 315B generated by external source computing system 103B. Further, as described herein, internal source data 315A may include data identifying and characterizing, for each predefined characteristic or feature associated with customers of the e-commerce entity, a global distribution and corresponding metric. Examples of the one or more predefined features that the global distributions and corresponding metrics may be associated with include channel features (e.g., channel breakdown ratios), in-store visit features (e.g., average number of trips to particular store(s), week-over-week trends for store visits, etc.), membership features (e.g., ratios of customers with various memberships), payment features (e.g., ratios of payment types), location features (e.g., distribution of customer by location), and online activity features (e.g., online activity ratios, week-over-week trends for online visits, etc.). Additionally, as described herein, reporting data 315B include data identifying and characterizing, for each predefined characteristic or feature associated with the customers of the e-commerce entity, a global distribution and corresponding metric. An example of the one or more metrics includes distribution of transactions by product category (e.g., total transaction amount for food purchases). As described herein, source data 315 may be a lower dimensionality than the data included or associated with the customer profile data 313 because internal source data 315A and/or reporting data 315B included in source data 315 may include ground truth information.

In some instances, constraint database 314 may store, constraint data 316. In some examples, clean data computing device 102 may be generated by clean data computing device 102. For example, clean data computing device 102 may obtain, from source computing systems 103 (e.g., internal source computing system 103A and external source computing system 103B) or constraint database 314, source data 315. Additionally, clean data computing device 102 may execute extraction engine 302. Executed extraction engine 302 may obtain one or more elements of source data 315. In some examples, the one or more elements of source data 315 may include data identifying and characterizing one or more predefined characteristics or features associated with the customers or e-commerce entity, and corresponding data identifying and characterizing the associated global distribution and related metric.

Moreover, clean data computing device 102 may execute constraint engine 303. Executed constraint engine 303 may generate constraint data 316 based on the data identifying and characterizing one or more predefined characteristics or features associated with the customers or e-commerce entity, and corresponding data identifying and characterizing the associated global distribution and related metric. The constraint data 316 may identify one or more constraints. Each of the one or more constraints may correspond to one of the identified global distributions and related metric. In various instances, the constraint data 316 may include data that characterizes, for each of the one or more constraints, the corresponding global distribution and related metric, and associated feature. As described herein, constraint data 316 may be of lower dimensionality than the data included or associated with the customer profile data 313 because the source data 315 (including one or more portions of internal source data and reporting data) that the constraint data 316 is based off of includes ground truth information.

In various examples, data repository 116 may include score database 318 and clean data database 320. In some instances, score database 318 may store score data 319 generated by clean data computing device 102. In such examples, score data 319 may identify and characterize, for each customer profile of the set of customer profiles, a score associated with each constraint identified from constraint data, the associated constraint, and an associated customer identifier of a corresponding customer profile. The score may indicate how close the one or more portions of the high dimensional data of the corresponding profile related to the global distribution and/or related metric of the constraint is to the global distribution and/or related metric of the constraint. In other instances, clean dataset database 320 may store clean datasets 321 of customer profiles generated by clean data computing device 102. In such examples, clean data computing device 102 may generate the clean datasets 321 of customer profiles based on the high-dimensional data included or associated with the set of customer profiles of customers of the e-commerce entity and the constraint data. The clean datasets 321 of customer profiles identify a representative subset of customer profiles of the set of customer profiles and include corresponding high-dimensional data.

As described herein, clean dataset 321 may have a lower level of sparsity, fragmentation and/or noise than the high-dimensional data of the set of customer profiles. Additionally, clean data computing device 102 may be configured to generate the clean dataset 321. In some examples, clean data computing device 102 may utilize the high dimensional data of customer profile data 313 of the set of customer profiles and constraint data 316 to generate clean dataset 321. In such examples, clean data computing device 102 may transmit the clean dataset 321 to the computing systems 105. The computing systems 105 may utilize the clean dataset 321 to extract insights and may implement a set of operations associated with the particular channel of the e-commerce entity, such as determining/predicting future purchase patterns of one or more customers of the e-commerce entity, determining/generating digital content campaigns for each of the customers of the e-commerce entity, and personalizing user experiences associated with the particular channel, based on such insights. In some instances, each of the multiple computing systems 105 may utilize machine learning or artificial intelligence processes when implementing said set of operations or determining such insights.

In various examples, the clean dataset 321 may identify a representative subset of customer profiles of the set of customer profiles and include corresponding high dimensional data. For example, clean data computing device 102 may generate, based at least on high dimensional data of the set of customer profiles and one or more constraints identified in the constraint data, the clean dataset 321. The clean dataset may be generated in accordance with the constraint data 316 such that the high dimensional data of the representative subset of customer profiles closely matches one or more global distributions of the set of customers and/or corresponding metric(s) of the one or more constraints.

In some examples, clean data computing device 102 may implement a set of operations that generate the clean dataset 321 of customer profiles. In such examples, the set of operations that clean data computing device 102 may implement include obtaining, from constraint database, constraint data 316. As described herein, the constraint data 316 may identify one or more constraints and include data that identifies and characterizes, for each of the one or more constraints, the corresponding global distribution and/or related metric, and associated feature. Additionally, the global distribution and/or metric may be ground truth information. Moreover, the set of operations that clean data computing device 102 may implement include determining, for each customer profile, a score for each constraint based on the constraint data 316, such as the global distributions and/or metric of the constraint, and the high dimensional data of the corresponding customer profile included in the customer profile data 313.

For example, clean data computing device 102 may obtain customer profile data 313 of the set of customers of the e-commerce entity. As described herein, customer profile data 313 may include the high-dimensional data associated with each of the set of customers identified in the customer profile data 313. Additionally, the clean data computing device 102 may execute analysis engine 304. Executed analysis engine 304 may, for one or more constraints identified in the constraint data 316, identify a feature associated with each of the one or more constraints. Moreover, executed analysis engine 304 may determine and identify, from the customer profile data 313 and for each of the set of customer profiles identified in the customer profile data 313, one or more portions of the corresponding high-dimensional data of the customer profile data 313 associated with the identified feature of each of the one or more constraints. Further, executed analysis engine 304 may determine, for each constraint and for each of the one or more customer profiles, a corresponding score by comparing the corresponding global distribution of the constraint and/or related metric with the determined and identified one or more portions of high-dimensional data of the customer profile data 313 associated with the feature of the constraint and the customer profile. In some instances, a score of a constraint may indicate how close the high dimensional data associated with or included with the corresponding customer profile and the constraint is to the global distribution of the customers of the e-commerce entity and/or related metric associated with the constraint.

In some examples, a global distribution of a feature may be associated with a particular type of distribution, such as a discrete probability mass function or continuous probability density function. In such examples, executed analysis engine 304 may determine a score of a particular constraint for a particular customer, based in part on the type of distribution associated with the global distribution of the particular constraint identified in constraint data 316 and high-dimensional data of customer profile data 313 associated with the particular customer. In some instances, a constraint identified in constraint data 316 may be associated with a global distribution that is an exponential distribution with a large number of discrete buckets. As an example, the constraint of constraint data 316 may be associated with an in-store visit feature. Additionally, constraint data 316 may include data identifying and characterizing the global distribution associated with the in-store visit feature. For instance, the global distribution may be associated with an average number of trips to store 109 in the past year. Moreover, the global distribution may be associated with an exponential distribution with a large number of discrete buckets-one for every possible number of visits. In such an example, executed analysis engine 304 may identify the in-store visit feature, the average number of trips to store 109, associated with a first constraint identified in constraint data 316. Additionally, executed analysis engine 304 may identify, for each of the one or more customer profiles identified in customer profile data 313, one or more portions of high-dimensional data of customer profile data 313 related to the number of in-store visits of the corresponding customer to store 109. Moreover, executed analysis engine 304 may, for each of the one or more customers identified in customer profile data 313, compare the corresponding one or more portions of high-dimensional data related to the number of in-store visits of the corresponding customer to store 109 to the data identifying and characterizing the global distribution and/or related metric of the in-store visit feature (e.g., by applying the data identifying and characterizing the global distribution of the in-store visit feature to the corresponding one or more portions of high-dimensional data related to the number of in-store visits). Based on the comparison, executed analysis engine 304 may generate, for each customer, a score. The score may indicate how close the one or more portions of the high dimensional data related to the number of in-store visits of the corresponding customer is to the global distribution and/or related metric of the in-store visit feature, such as the average number of trips to store 109.

In some instances, based on the high-dimensional data of customer profile data 313 and the constraint data, executed analysis engine 304 may determine additional information associated with the one or more portions of high-dimensional data. Additionally, executed analysis engine 304 may compare the additional information to the global distribution and/or related metric of the feature. Following the example above, for example, executed analysis engine 304 may determine, for each customer profile identified in customer profile data 313, a number of visits the customer has made to store 109 in the past year (e.g., five times in the past year) based on the one or more portions of high-dimensional data of customer profile data 313 related to the number of in-store visits of the corresponding customer to store 109. Additionally, executed analysis engine 304 may, determine the global distribution of the in-store visit feature and/or related metric, such as, for the set of customers, an exponential distribution with an average 25 trips to store 109 in the past year, based on constraint data 316. Moreover, for each customer profile identified in customer profile data 313, executed analysis engine 304 may compare the corresponding determined number of visits the corresponding customer has made to store 109 in the past year to the global distribution of the in-store visit feature and/or related metric, such as the average 25 trips to store 109 in the past year.

In other instances, a constraint identified in constraint data 316 may be associated with a global distribution that is a distribution with a small number of discrete buckets. As an example, the constraint identified in constraint data 316 may be associated with a channel feature. Additionally, constraint data 316 may include data identifying and characterizing the global distribution associated with the channel feature. In some instances, the global distribution may be associated with overall channel breakdown of customers or channel break down ratio. Moreover, the overall channel breakdown of customers or channel breakdown ratio may include a small number of discrete buckets. For instance, the overall channel breakdown of customers or channel breakdown ratio may include a bucket associated with the percentage of customers that only make online-transactions, a bucket associated with percentage of customers that only make in-store transactions, and a bucket associated with percentage of customer that make both in-store transactions and online-transactions. Additionally, each of the small number of discrete buckets may be associated with or assigned a true ratio based on the high dimensional data (e.g., online-transaction data 313A and/or in-store transaction data 313B) of the set of customers (e.g., the percentage or ratio of online-transactions to in-store transactions to both online and in-store transactions may be 20%:40%:40%).

For example, executed analysis engine 304 may identify the channel feature, the overall channel breakdown of customers or channel breakdown ratio, associated with the constraint identified in the constraint data 316. Additionally, executed analysis engine 304 may identify, for each of the set of customer profiles identified in customer profile data 313, one or more portions of high-dimensional data related to online and/or in-store transactions (e.g., online-transaction data 313A and/or in-store transaction data 313B). Moreover, executed analysis engine 304 may, determine, for each customer profile identified in customer profile data 313, whether the corresponding customer only makes purchases online, only makes purchases in-store or both. Further, executed analysis engine 304 may, determine, for each customer profile identified in customer profile data 313, which discrete bucket the customer profile falls into based on whether the corresponding customer only makes transactions online, only makes transactions in-store or makes both online and in-store transactions. Based on which discrete bucket the customer profile falls into, executed analysis engine 304 may determine a score for the corresponding customer profile in accordance with the corresponding true ratio or percentage associated with the discrete bucket the corresponding customer profile falls into. For instance, clean data computing device 102 may determine, for each of the one or more customer profiles identified in customer profile data 313, one or more portions of high-dimensional data of a customer profile data 313 associated with the channel feature. The one or more portions of high dimensional data of the customer profile data 313 may indicate the corresponding customer makes on-line and in-store purchases. As such, executed analysis engine 304 may determine that the customer profile may receive a score of 0.4.

In various instances, a constraint identified in the constraint data 316 may be associated with a global distribution that is a time series distribution with a large number of overlapping buckets. As an example, the constraint identified in constraint data 316 may be associated with a purchase feature. Additionally, constraint data 316 may identify and characterize the global distribution associated with the constraint. In some instances, the global distribution may be associated with a distribution of transactions of the set of customers by product category over a particular time interval. For instance, based on constraint data 316, executed analysis engine 304 may identify the constraint and the feature associated with the constraint, the purchase feature. Additionally, executed analysis engine 304 may identify the global distribution of the constraint based on constraint data 316. The global distribution may be the total purchase amount of the set of customers related to food items per week for the last three years. Additionally, based on customer profile data 313, executed analysis engine 304 may identify, for each of the set of customer profiles identified in customer profile data 313, one or more corresponding portions of high dimensional data related to the global distribution of the identified constraint and feature—the purchase amount of food items for the last three years (e.g., online-transaction data 313A and/or in-store transaction data 313B). Based on the one or more corresponding portions of high-dimensional data, executed analysis engine 304 may further determine, for each of the set of customers, a week-to-week, during the three-year time period, total purchase amount related to food items. Moreover, executed analysis engine 304 may compare, for each of the set of customer profiles identified in the customer profile data 313, the determined week-to-week total purchase amount related to food items to the global distribution of the total purchase amount per week for the three-year time interval. Based on the comparison, executed analysis engine 304 may determine, for each of the one or more customer profiles identified in the customer profile data 313, a score. In some instances, clean data computing device 102 may determine the score by utilizing similarity/distance measures (e.g., cosine similarity, mean squared error, etc.).

In some examples, the set of operations that clean data computing device 102 may implement to generate clean dataset 321 may include de-fragmentation operations. In such examples, clean data computing device 102 may execute defragmentation engine 305 to implement the defragmentation operations. Additionally, the de-fragmentation operations remove or lessen the effects of fragmentation-related impurities (e.g., lessen the chance fragmented customer profiles of one or more customers are included in the clean dataset 321). In some examples, executed defragmentation engine 305 may implement the defragmentation operations that include normalizing the scores of each constraint associated with each of the set of customer profiles. In some instances, normalizing the scores may include normalizing the size of each discrete bucket of the global distributions of each constraint. For instance, based on the constraint data 316, executed defragmentation engine 305 may determine the actual distribution of the set of customers that have the associated score, and then normalize the score of a particular customer utilizing the determined actual distribution (e.g., dividing the score of the customer with the actual distribution).

In some instances, executed defragmentation engine 305 may determine the normalized score of a particular customer of a particular constraint according to the following equations:

$$E [ {b}_{i}^{″} ] = \frac{{b}_{i}^{′}}{{\sum }_{j = 1}^{m} {b}_{j}^{′}} \qquad ( 1 )$$

$$E [ {b}_{i}^{″} ] = \frac{{b}_{i}^{′} * {b}_{i}^{′}}{{\sum }_{j = 1}^{m} {b}_{j} * {b}_{j}^{′}} \qquad ( 2 )$$

$$E [ {b}_{i}^{″} ] = \frac{{b}_{i}^{′} * {b}_{i}^{′}}{{\sum }_{j = 1}^{m} {b}_{j} * \frac{{b}_{j}^{′}}{{b}_{j}}} = \frac{{b}_{i}^{′}}{{\sum }_{j = 1}^{m} {b}_{j}^{′}} = {b}_{i}^{′} \qquad ( 3 )$$

where for each constraint Dₓ, the probability mass of each of these discrete buckets of a corresponding global distribution may be denoted by b=(b1, . . . , bm). Additionally, b′=(b′₁, . . . , b′ₘ) may represent the desired bucket distribution of the set of customers associated with the corresponding global distribution, and b″=(b″₁, . . . , b″ₘ) may represent the actual distribution of the set of customers.

Equation 1 represents the goal of clean dataset 321 for each constraint. Given that the probability masses of all the buckets sum to 1 in any distribution, the expected frequency of bucket i in clean dataset 321 should equal the target frequency b′ᵢ, as represented by equation 2. Equation 3 represents a clean dataset 321 that has been normalized (e.g., clean dataset 321 that has had the effects of fragmented customer profile data removed/lessened) or the equation for the normalized score of a particular customer for a particular constraint. Equation 3 solves the problem where equation 2 does not guarantee that equation 2 equals b′ᵢ. Equation 3 is the scores given to customer profiles or customer profile data (represented by b′) of equation 2 divided by b.

As an example, following the example regarding the constraint associated with channel feature (given the small number of discrete buckets) each customer profile of the set of customers of the e-commerce entity may have a score of 0.2 if the high-dimensional data of the corresponding customer profile indicates the corresponding customer only shops online, 0.4 if the high-dimensional data of the corresponding customer profile indicates the corresponding customer only in-store (e.g., store 109), or 0.4 if the high-dimensional data of the corresponding customer profile indicates the corresponding customer shops online and in-store. Additionally, defragmentation engine 305 may, based on one or more portions of constraint data 316 that characterize and identify the global distribution of the set of customers associated with the channel feature, determine the actual distribution of the set of customers that only shop online, only in-store, and online and in-store are 8%, 54% and 38%, respectively. Based at least on the determined actual distribution of the set of customers and the scores of the channel feature constraint of the set of customer profiles of the set of customers of the e-commerce entity, defragmentation engine 305 may determine, for each of the set of customer profiles identified in the customer profile data 313, the normalized score associated with the channel feature constraint.

For instance, for each of the set of customer profiles identified in customer profile data 313, defragmentation engine 305 may divide the scores associated with the channel feature constraint by the corresponding actual distribution (e.g., for customer profiles with the high-dimensional data indicating the corresponding customer only shops online, clean data computing device 102 may divide the score of 0.2 by the actual distribution of customers that only shop online—0.08; for customer profiles with the high-dimensional data indicating the corresponding customer only shops in-store, clean data computing device 102 may divide the score of 0.4 by the actual distribution of customers that only shop online—0.54; and for customer profiles with the high-dimensional data indicating the corresponding customer shops online and in-store, clean data computing device 102 may divide the score of 0.4 by the actual distribution of customers that only shop online—0.38).

As an another example, following the example regarding the constraint associated with an in-store visit feature (given the large number of discrete buckets for the exponential type distribution) a particular customer profile of the set of customers of the e-commerce entity may have a score of 0.15 for the determined six visits to store 109 in the past year. Additionally, defragmentation engine 305 may, based on one or more portions of constraint data 316 that characterize and identify the global distribution of the set of customers associated with the in-store visit feature, determine the actual distribution of customers that visited a store of e-commerce entity 6 times in the past year is 20%. Based at least on the determined actual distribution of customers and the score of the in-store visit feature constraint of the particular customer profile, defragmentation engine 305 may determine, for the particular customer profile identified in the customer profile data 313, the normalized score associated with the in-store visit feature constraint. For instance, for the particular customer profile, defragmentation engine 305 may divide the score associated with the in-store visit feature constraint by the corresponding actual distribution (e.g., clean data computing device 102 may divide the score of 0.15 by 0.2).

In other examples, the set of operations that clean data computing device 102 may implement to generate clean dataset 321 may include aggregating, for each of the one or more customer profiles, the normalized scores of each constraint. In such examples, clean data computing device 102 may execute aggregator engine 306 to aggregate, for each of the one or more customer profiles identified in customer profile data 313, the normalized scores of each constraint. For instance, aggregator engine 306 may obtain, from score database 318, score data 319. The score data 319 may include data that identifies one or more scores, data that identifies and characterizes, for each of the one or more scores, a particular constraint, and data that identifies and characterizes, for each of the one or more scores, the associated customer (e.g., an email address, a phone number, a membership number, etc.). Additionally, for each of the one or more customer profiles identified in customer profile data 313, aggregator engine 306 may identify a customer identifier of each of the one or more customer profiles identified in customer profile data 313 based on the customer profile data 313. Based on the one or more customer identifiers identified from customer profile data 313 and score data 319, aggregator engine 306 may identify, for each of the one or more customer profiles identified in customer profile data 313, one or more scores that are associated with the corresponding customer identifier of customer profile data 313. Aggregator engine 306 may aggregate, for each of the one or more customer profiles identified from customer profile data 313, the one or more identified scores associated with the corresponding customer identifier to generate an aggregate score (e.g., by multiplying the individual scores together).

In various examples, the set of operations that clean data computing device 102 may implement to generate the clean dataset 321 may include sampling operations. In such examples, clean data computing device 102 may execute sampler engine 307 to implement the sampling operations. Additionally, the sampling operations may identify and select a subset of customer profiles from the set of customer profiles. Moreover, sampler engine 307 may select a subset of customer profiles from the set of customer profiles, based on normalized aggregate score of each of the set of customer profiles. In some examples, the sampler engine 307 may normalize the aggregate scores of all the customer profiles of the set of customer profiles. In other examples, sampler engine 307 may normalize the aggregate scores of all the customer profiles of the set of customer profiles such that the aggregate scores of all the customer profiles sum to 1. The normalized aggregate scores may indicate the true probability that a customer profile is to be selected for the clean dataset.

In some instances, executed sampler engine 307 may randomly select subset of customer profiles based on the normalized aggregate score of each of the set of customer profiles. In other instances, executed sampler engine 307 may weight each of the normalized aggregate score of each of the set of customer profiles and then randomly select the subset of customer profiles from the set of customer profiles, without replacement, based on the weighted and normalized aggregate score of each of the set of customer profiles. Further, sampler engine 307 may generate a clean dataset 321 based on the selected subset of customer profiles. As described herein, the clean dataset 321 may include data, from customer profile data 313, that identifies and characterizes each of the selected subset of customer profiles, along with corresponding high-dimensional data. Given that the cumulative high-dimensional data of the customer profiles of the selected subset of customer profiles is determined to closely reflect the global distributions of each constraint the weighted random sampling is based off of, and that the scores were normalized to remove the effects or lessen the fragmentation effects that may exist in the high-dimensional data of the set of customer profiles, the clean dataset 321 may be less noisy, sparse and fragmented than the high-dimensional data of the set of customer profiles.

In various examples, clean data computing device 102 may implement a set of operations that evaluate whether the clean dataset 321 satisfies the global distributions of one or more constraints. In such examples, clean data computing device 102 may execute evaluator engine 322. Executed evaluator engine 322 may implement a set of operations that evaluate whether the clean dataset 321 satisfies the global distributions of one or more constraints. In some instances, executed evaluator engine 322 may only utilize a portion of the constraints identified in constraint data 316 in generating the clean datasets 321. In such instances, executed evaluator engine 322 may utilize the remaining constraints as testing constraints.

For instance, when generating the clean dataset 321, clean data computing device 102 may not have utilized a constraint associated with channel breakdown ratios. As such, executed evaluator engine 322 may obtain constraint data 316 and identify the global distribution and/or metric associated with the constraint not utilized when generating clean dataset 321. Additionally, based on the high-dimensional data of each of the customer profiles included in the clean dataset 321, executed evaluator engine 322 may obtain portions of the high-dimensional data that is associated with the identified constraint and determine and generate aggregate statistics associated with the identified constraint, (e.g., the ratio of customers identified in the clean dataset of customers, that only shop online, only shop in-store, and shop online and in-store). Further, executed evaluator engine 322 may determine an accuracy of the clean dataset 321 by comparing the determined and generated aggregate statistics associated with the identified constraint to the global distribution and/or metric associated with the constraint (e.g., due to the inclusion of ground truth information of one or more aspects or portions of the customer profile data 313). In some examples, executed evaluator engine 322 may determine whether the determined accuracy falls outside a predetermined acceptable margin of error. In examples where executed evaluator engine 322 determines the accuracy of clean dataset 321 falls outside an acceptable margin of error, executed evaluator engine 322 may transmit a notification or message to executed sampler engine 307. The notification or message may indicate that the determined accuracy of clean dataset 321 is outside the acceptable margin of error. In response to the notification or message, executed sampler engine 307 may reselect the subset of customer profiles. Additionally, executed sampler engine 307 may generate another clean dataset 321 based on the reselected subset of customer profiles. Alternatively, in examples where executed evaluator engine 322 determines the accuracy of clean dataset 321 falls within an acceptable margin of error, executed evaluator engine 322 may instruct executed sampler engine 307 to transmit the clean dataset 321 to one or more computing systems 105 (not shown in FIG. 3).

In some examples, the number of customer profiles to be selected for subset of customer profiles, may depend with the number of constraints being utilized in generating the clean dataset, and the acceptable range of error. For example, the larger the number of constraints are used by clean data computing device 102 or the smaller the acceptable margin of error, the smaller the number of customer profiles are to be selected for the subset of customer profiles. Alternatively, in another example, the smaller the number of constraints are used by clean data computing device 102 or the larger the acceptable margin of error, the larger the number of customer profiles are to be selected for the subset of customer profiles.

### Methodology

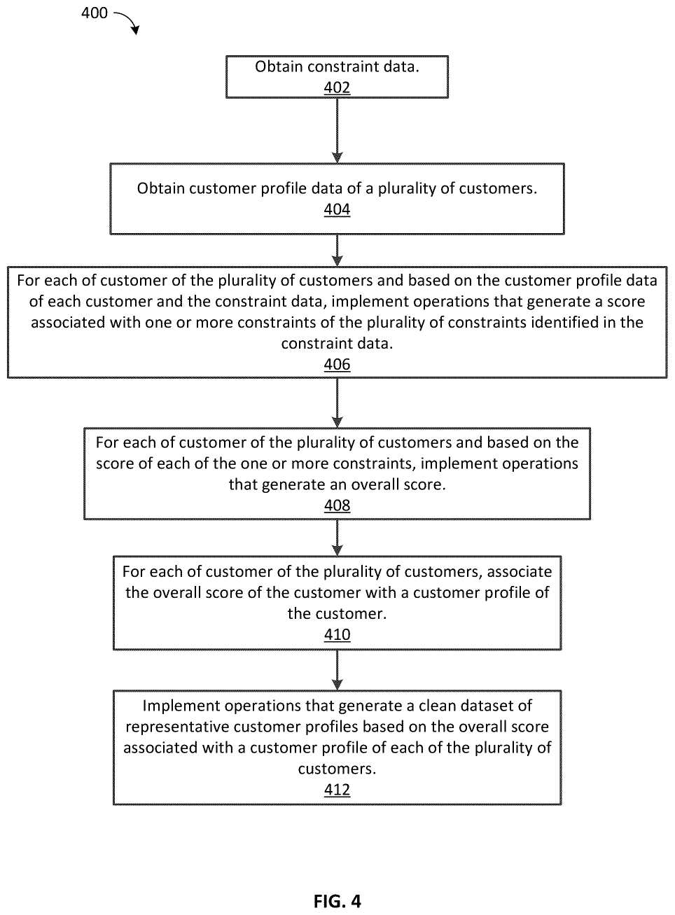

FIG. 4 illustrates an example method that can be carried out by the clean data computing device 102 of FIG. 1. In describing an example method of FIGS. 4, reference is made to elements of FIG. 1-3 for purpose of illustrating a suitable component for performing a step or sub-step being described.

With reference to example method 400 of FIG. 4, clean data computing device 102 may, obtain constraint data 316 (step 402). In some examples, constraint data 316 may include may include data that characterizes, for each of the one or more constraints, the corresponding global distribution and related metric, and associated feature. In some instances, executed constraint engine 303 of clean data computing device 102 may generate constraint data 316 based on source data 315 generated by source computing systems 103 (e.g., internal source computing system 103A and external source computing system 103B).

Additionally, clean data computing device 102 may obtain customer profile data 313 of a plurality of customers associated with an e-commerce entity (step 404). Customer profile data 313 may identify and characterize a customer profile of each of the one or more customers of the e-commerce entity. In some examples, clean data computing device 102 may receive, from one or more data sources, such as server 104, membership server 106 and workstation(s) 109B, one or more data elements of the customer profile data 313. In such examples, the one or more data elements of the customer profile data 313 may include a customer identifier or data that identifies the corresponding customer (e.g., an email address, a phone number, a membership number, etc.) associated with each customer profile. Additionally, the one or more data elements of the customer profile data 313 may include one or more portions of corresponding additional data from online-transaction data 313A, one or more portions of corresponding additional data from in-store transaction data 313B, one or more portions of corresponding user session data 313C, and one or more portions of corresponding membership data 313D.

Moreover, clean data computing device 102 may, for each customer of the plurality of customers and based on the customer profile data 313 of each customer and the constraint data 316, implement operations that generate a score associated with one or more constraints of the plurality of constraints identified in constraint data 316 (step 406). For example, executed analysis engine 304 may, for each constraint, identify a feature associated with the constraint and a global distribution and/or corresponding metric associated with the feature, based on the constraint data 316. Moreover, executed analysis engine 304 may determine and identify, from the customer profile data 313 and for each customer profile of each of the plurality of customers identified in the customer profile data 313, one or more portions of the corresponding high-dimensional data of the customer profile data 313 associated with the feature and the customer profile. Further, for each constraint and for each customer profile of each of the plurality of customers identified in the customer profile data 313, executed analysis engine 304, may determine a corresponding score by comparing the global distribution of the constraint and/or related metric with the determined and identified one or more portions of high-dimensional data of the customer profile data 313 associated with the feature of the constraint and the customer profile. In some instances, a score of a constraint may indicate how close the high dimensional data associated with or included with the corresponding customer profile is to the global distribution of the customers of the e-commerce entity and/or related metric associated with the constraint.

Further, for each of customer of the plurality of customers and based on the score of each of the one or more constraints, clean data computing device 102 may implement operations that generate an overall score (step 408). Additionally, for each of customer of the plurality of customers, clean data computing device 102 may associate the overall score of each customer with a corresponding customer profile of the customer (step 410). In some examples, executed aggregator engine 306 may generate, for each of customer of the plurality of customers, the overall score by aggregating one or more scores associated with a corresponding customer profile. For instance, executed aggregator engine 306 may obtain, from score database 318, score data 319. The score data 319 may include data that identifies one or more scores, data that identifies and characterizes, for each of the one or more scores, a particular constraint, and data that identifies and characterizes, for each of the one or more scores, the associated customer (e.g., an email address, a phone number, a membership number, etc.). Additionally, for each of the one or more customer profiles identified in customer profile data 313, executed aggregator engine 306 may identify a customer identifier of each of the one or more customer profiles identified in customer profile data 313 based on the customer profile data 313. Based on the one or more customer identifiers identified from customer profile data 313 and score data 319, executed aggregator engine 306 may identify, for each of the one or more customer profiles identified in customer profile data 313, one or more scores that are associated with the corresponding customer identifier of customer profile data 313. Aggregator engine 306 may aggregate, for each of the one or more customer profiles identified from customer profile data 313, the one or more identified scores associated with the corresponding customer identifier to generate an aggregate score (e.g., by multiplying the individual scores together).

In some instances, the scores of score data 319 may be normalized prior to being aggregated by executed aggregator engine 306. For example, executed defragmentation engine 305 may normalize, for a customer profile of each of a plurality of customers identified in customer profile data 313, one or more scores associated with the customer profile. For instance, for each score of each customer profile, executed defragmentation engine 305 may determine the actual distribution of the plurality of customer identified in customer profile data 313 that have the score, based on constraint data 316. Additionally, executed defragmentation engine 305 may, for each score of each customer profile, normalize the score utilizing the determined actual distribution (e.g., dividing the score of the customer with the actual distribution).

Referring back to FIG. 4, clean data computing device 102 may implement operations that generate clean dataset 321 of representative customer profiles based on the overall score associated with a customer profile of each of the plurality of customers (step 412). In some examples, executed sampler engine 307 may implement sampling operations that generate the clean dataset 321 based on the overall score or aggregate score associated with the customer profile of each of the plurality of customers. In some instances, executed sampling operations may implement operations that generate clean dataset 321 by identifying and selecting a subset of customer profiles for clean dataset 321 based on the aggregate scores of each customer profile of the plurality of customers. In other instances, executed sampler engine 307 may normalize the aggregate scores of all the customer profiles of the plurality of customers and select the subset of customer profiles based on the associated normalized and aggregated scores of each customer profile of the plurality of customers. In other instances, executed sampler engine 307 may normalize the aggregate scores of all the customer profiles of the plurality of customers such that the aggregate scores of all the customer profiles sum to 1. The normalized aggregate scores may indicate the true probability that a customer profile is to be selected for the clean dataset.

As described herein, the selected subset of customer profiles and corresponding portions of high-dimensional data of customer profile data 313 may be included in clean dataset 321. For instance, the clean dataset 321 may generate clean dataset 321 that includes data, from customer profile data 313, that identifies and characterizes each of the selected subset of customer profiles, along with corresponding high-dimensional data. In some instances, executed sampler engine 307 may randomly select the subset of customer profiles from the plurality of customer profiles identified in customer profile data 313, based on the normalized aggregate score of each customer profile of the plurality of customer profiles. In other instances, executed sampler engine 307 may weight each of the aggregate scores of each customer profile of the plurality of customers and then randomly select the subset of customer profiles from the plurality of customer profiles identified in customer profile data 313, without replacement, based on the weighted and normalized aggregate score of each customer profile of the plurality of customers.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

The foregoing is provided for purposes of illustrating, explaining, and describing embodiments of these disclosures. Modifications and adaptations to these embodiments will be apparent to those skilled in the art and may be made without departing from the scope or spirit of these disclosures.

What is claimed is:

1. A system comprising:
a memory resource storing instructions; and
one or more processors coupled to the memory resource, the one or more processors being configured to execute the instructions to:
obtain constraint data, the constraint data including data that identifies and characterizes a plurality of constraints and data that, for each of the plurality of constraints, identifies and characterizes a global distribution associated with the corresponding constraint;
obtain customer profile data of a plurality of customers associated with the system;
for each customer of the plurality of customers:
based on the customer profile data of the customer and the constraint data, implement operations that generate a score associated with one or more constraints of the plurality of constraints;
based on the score of each of the one or more constraints, implement operations that generate an overall score, the overall score indicating a closeness between the customer profile data of the customer to at least the global distribution of each of the one or more constraints; and
associate the overall score with a customer profile of the customer; and
implement operations that generate a clean dataset based on the overall score associated with a customer profile of each of the plurality of customers.

2. The system of claim 1, wherein the one or more processors are configured to execute the instructions further to:
based on source data, generating the constraint data.

3. The system of claim 2, wherein each of the plurality of constraints identified in the constraint data is associated with a type of distribution, and wherein the type of distribution includes at least one of a discrete probability mass function or a continuous probability density function.

4. The system of claim 2, wherein the source data is obtained from one or more computing systems.

5. The system of claim 1, wherein the operations that generate the score associated with each of the plurality of constraints includes:
for each of the one or more constraints:
identifying one or more portions of the customer profile data of the customer that is associated with the constraint; and
comparing the one or more portions of the customer profile data of the customer with the global distribution of the constraint.

6. The system of claim 1, wherein the operations that generate the overall score includes:
aggregating the score associated with each of the one or more constraints.

7. The system of claim 6, wherein the operations that generate the overall score includes:
normalizing the overall score.

8. The system of claim 7, wherein the operations that generate the clean dataset includes:
based on the normalized overall score of each customer profile of each of the plurality of customers, select a set of customers of the plurality of customers; and
generate the clean dataset based on the selected set of customers, the clean dataset including at least one or more portions of customer profile data of each of the selected set of customers.

9. The system of claim 1, wherein the operations that generate the clean dataset includes:
implementing a verification process that determines an accuracy of the clean dataset.

10. The system of claim 1, wherein the operations that generate the score associated with the one or more constraints includes:
implementing a de-fragmentation processes.

11. A computer-implemented method comprising:
obtaining, by a processor of a computing system, constraint data, the constraint data including data that identifies and characterizes a plurality of constraints and data that, for each of the plurality of constraints, identifies and characterizes a global distribution associated with the corresponding constraint;
obtaining, by the processor of the computing system, customer profile data of a plurality of customers associated with a system;
for each customer of the plurality of customers:
based on the customer profile data of the customer and the constraint data, implementing, by the processor of the computing system, operations that generate a score associated with one or more constraints of the plurality of constraints;
based on the score of each of the one or more constraints, implementing, by the processor of the computing system, operations that generate an overall score, the overall score indicating a closeness between the customer profile data of the customer to at least the global distribution of each of the one or more constraints; and
associating, by the processor of the computing system, the overall score with a customer profile of the customer; and
implementing, by the processor of the computing system, operations that generate a clean dataset based on the overall score associated with a customer profile of each of the plurality of customers.

12. The computer-implemented method of claim 11, further comprising:
based on source data, generating the constraint data.

13. The computer-implemented method of claim 12, wherein each of the plurality of constraints identified in the constraint data is associated with a type of distribution, and wherein the type of distribution includes at least one of a discrete probability mass function or a continuous probability density function.

14. The computer-implemented method of claim 12, wherein the source data is obtained from one or more computing systems.

15. The computer-implemented method of claim 11, wherein the operations that generate the score associated with each of the plurality of constraints includes:
for each of the one or more constraints:
identifying one or more portions of the customer profile data of the customer that is associated with the constraint; and
comparing the one or more portions of the customer profile data of the customer with the global distribution of the constraint.

16. The computer-implemented method of claim 11, wherein the computer-implemented method further comprises:
aggregating the score associated with each of the one or more constraints.

17. The computer-implemented method of claim 16, wherein the computer-implemented method further comprises:
normalizing the overall score.

18. The computer-implemented method of claim 17, wherein the operations that generate the clean dataset includes:
based on the normalized overall score of each customer profile of each of the plurality of customers, select a set of customers of the plurality of customers; and
generate the clean dataset based on the selected set of customers, the clean dataset including at least one or more portions of customer profile data of each of the selected set of customers.

19. The computer-implemented method of claim 11, wherein the operations that generate the clean dataset includes:
implementing a verification process that determines an accuracy of the clean dataset.

20. A non-transitory computer-readable medium storing instructions, that when executed by one or more processors, causes a system to:
obtain constraint data, the constraint data including data that identifies and characterizes a plurality of constraints and data that, for each of the plurality of constraints, identifies and characterizes a global distribution associated with the corresponding constraint;
obtain customer profile data of a plurality of customers associated with the system;
for each customer of the plurality of customers:
based on the customer profile data of the customer and the constraint data, implement operations that generate a score associated with one or more constraints of the plurality of constraints;
based on the score of each of the one or more constraints, implement operations that generate an overall score, the overall score indicating a closeness between the customer profile data of the customer to at least the global distribution of each of the one or more constraints; and
associate the overall score with a customer profile of the customer; and
implement operations that generate a clean dataset based on the overall score associated with a customer profile of each of the plurality of customers.
